(19) United States
(12) Patent Application Publication
(10) Pub. No.: US 2025/0037930 A1
(43) Pub. Date: Jan. 30, 2025

(54) TRANSFORMER FOR ON-BOARD CHARGER OF ELECTRIC VEHICLE

(71) Applicant: Atum Co., Ltd., Ansan-si (KR)

(72) Inventor: Taeksoo HAN, Seoul (KR)

(21) Appl. No.: 18/777,528

(22) Filed: Jul. 18, 2024

(30) Foreign Application Priority Data
Jul. 28, 2023 (KR) 10-2023-0099134

(51) Int. Cl. H01F 27/32; B60L 53/22; H01F 27/28

(52) U.S. Cl. CPC H01F 27/325; B60L 53/22; H01F 27/2828; H01F 27/2866; B60L 2210/30

(57) ABSTRACT

Provided relates to a transformer for an on-board charger (OBC) of an electric vehicle, the transformer including: a flat primary coil for receiving current from an electric vehicle charger; a lower secondary coil element located under the primary coil in such a way as to come into close contact with an underside of the primary coil and generate induced current by means of magnetic induction of the current flowing to the primary coil to supply the generated induced current to a high-voltage battery; and an upper secondary coil element located above the primary coil in such a way as to come into close contact with a top of the primary coil and generate induced current by means of magnetic induction of the current flowing to the primary coil to supply the generated induced current to the high-voltage battery.

### BACKGROUND OF THE DISCLOSURE

### Cross Reference to Related Application of the Disclosure

The present application claims the benefit of Korean Patent Application No. 10-2023-0099134 filed in the Korean Intellectual Property Office on Jul. 28, 2024, the entire contents of which are incorporated herein by reference.

### FIELD OF THE DISCLOSURE

The present disclosure relates to a transformer for an on-board charger (OBC) of an electric vehicle.

### BACKGROUND OF THE RELATED ART

A plug-in hybrid electric vehicle (PHEV) and an electric vehicle (EV) (hereinafter, referred to collectively as electric vehicle) is provided with a charger for charging a high-voltage battery that drives the motor of the vehicle with 200V AC, and the charger is called an on-board charger (OBC).

The electric vehicle is provided with an OBC for charging a high-voltage battery that drives the motor of the vehicle with commercial AC power (200V AC) supplied from an electric vehicle charger, the high-voltage battery charged with power converted by and supplied from the OBC, a low voltage DC-DC converter (LDC) for converting a high voltage of the high-voltage battery into a low voltage of 12V and supplying power to electrical components of the vehicle.

The OBC built in an electric vehicle is configured to have a first converter for performing full-wave rectification for the 220V AC voltage supplied from the electric vehicle charger through a bridge diode and boosting the full-wave rectified voltage through a boost converter circuit, a second converter for converting the rectified voltage generated from the first converter into high-frequency AC voltage through a full bridge circuit, a transformer for converting the high-frequency AC voltage of the second converter into a higher voltage and physically insulating the 220V AC from the high-voltage battery, and a rectifier for rectifying and smoothing high-frequency AC high voltage converted through the transformer, converting the rectified AC high voltage into DC voltage, and supplying the DC voltage to the high-voltage battery.

Here, an explanation of a configuration of a transformer for an OBC in a conventional practice will be given.

According to the conventional transformer for the OBC, a primary coil is wound around a bobbin specially made, and next, an insulating tape is applied to the primary coil wound, so that the primary coil is insulated.

After that, a secondary coil is wound around the primary coil.

Next, an insulating tape is applied to the secondary coil wound, so that the secondary coil is insulated.

If the winding work for the secondary coil is performed three times, the insulating tapes are applied to the secondary coils wound whenever the secondary coils are wound, so that the secondary coils are insulated.

However, the conventional transformer for the OBC has the following disadvantages.

Firstly, the transformer itself is considerably large in size. That is, as the secondary coils are wound coaxially on the primary coil wound around the bobbin, the size of the transformer itself is bulky, thereby undesirably causing even a size of the OBC to increase.

Secondly, as the assembly processes of winding the primary coil, insulating the primary coil with the insulating tape wound around the primary coil, winding the secondary coils around the insulating tape, and insulating the secondary coils with the insulating tapes wound around the secondary coils are repeatedly performed, the number of assembly processes increases, thereby undesirably lowering the productivity of the transformer.

Lastly, as the primary coil and the secondary coils are wound manually, the coils wound are not aligned with one another to cause lots of losses therebetween, thereby undesirably making electromagnetic interference (EMI) shielding performance deteriorated badly.

### SUMMARY OF THE DISCLOSURE

Accordingly, the present disclosure has been made in view of the above-mentioned problems occurring in the related art, and it is an object of the present disclosure to provide a transformer for an on-board charger (OBC) of an electric vehicle that is capable of allowing a primary coil and secondary coils to be kept insulated from one another even at a high voltage in the range of several to tens of kV.

It is another object of the present disclosure to provide a transformer for an OBC of an electric vehicle that is capable of ensuring winding uniformization and alignment of a primary coil and secondary coils, thereby improving efficiencies and EMI shielding performance.

It is yet another object of the present disclosure to provide a transformer for an OBC of an electric vehicle that is capable of allowing the sectional areas and surface areas of a primary coil and secondary coil elements to increase, thereby improving skin effect and reducing the generation of heat.

It is still another object of the present disclosure to provide a transformer for an OBC of an electric vehicle that is capable of decreasing the number of processes, thereby achieving the reduction in a machining cost.

It is yet still another object of the present disclosure to provide a transformer for an OBC of an electric vehicle that is capable of being reduced in height and volume (size), so that the space occupied by the OBC in the electric vehicle becomes small, thereby improving the product competitiveness of the OBC.

It is another object of the present disclosure to provide a transformer for an OBC of an electric vehicle that is capable of decreasing a loss between a primary coil and secondary coil elements, thereby enhancing efficiency therebetween.

It is yet another object of the present disclosure to provide a transformer for an OBC of an electric vehicle that is capable of supplying large current and high voltage even if the transformer is small in size.

It is still another object of the present disclosure to provide a transformer for an OBC of an electric vehicle that is capable of improving a degree of contact of a primary coil itself.

It is yet another object of the present disclosure to provide a transformer for an OBC of an electric vehicle that is capable of allowing the number of assembling processes for a primary coil to be reduced, thereby improving product productivity and price competitiveness.

It is yet still another object of the present disclosure to provide a transformer for an OBC of an electric vehicle that is capable of performing wiring work of a primary coil to secondary coil elements very easily, conveniently, and accurately, and needing no additional terminal arrangement (wiring) for the primary coil and the secondary coils.

It is another object of the present disclosure to provide a transformer for an OBC of an electric vehicle that is capable of performing wiring work with other parts easily and conveniently.

It is still another object of the present disclosure to provide a transformer for an OBC of an electric vehicle that is capable of allowing arrangements of coils to be regular by using flat copper wires, thereby achieving the uniformization in quality.

It is yet another object of the present disclosure to provide a transformer for an OBC of an electric vehicle that is capable of allowing wiring work to be performed by even an unskilled worker quickly and accurately, without any erroneous wiring.

To accomplish the above-mentioned objects, according to the present disclosure, there is provided a transformer for an on-board charger (OBC) of an electric vehicle, the OBC of the electric vehicle being adapted to charge a high-voltage battery of the electric vehicle with commercial AC power (200V AC) supplied from an electric vehicle charger, the transformer including: a flat primary coil for receiving current from the electric vehicle charger; a lower secondary coil element located under the primary coil in such a way as to come into close contact with an underside of the primary coil and generate induced current by means of magnetic induction of the current flowing to the primary coil to supply the generated induced current to the high-voltage battery; and an upper secondary coil element located above the primary coil in such a way as to come into close contact with a top of the primary coil and generate induced current by means of magnetic induction of the current flowing to the primary coil to supply the generated induced current to the high-voltage battery, wherein the primary coil is formed of an adhesion type insulating tape-covered conductive wire made by covering an insulating tape on a conductive wire and applying an adhesive onto the outer peripheral surface of the insulating tape to form a bonding layer, and the primary coil is provided to the form of a coil by winding the adhesion type covered conductive wire in such a way as to have multiple turns, while forming a first central hole on a center thereof, fusing and curing the applied bonding layer, and joining the close contact portions of the adhesion type covered conductive wire by means of the fusing.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a perspective view showing a transformer for an OBC of an electric vehicle according to a first embodiment of the present disclosure;

FIG. 2 is an exploded perspective top view showing the transformer for an OBC of an electric vehicle according to the first embodiment of the present disclosure;

FIG. 3 is an exploded perspective bottom view showing the transformer for an OBC of an electric vehicle according to the first embodiment of the present disclosure;

FIG. 4 is a sectional view showing the transformer for the OBC according to the present disclosure wherein a mounting member and upper and lower magnetic cores are removed;

FIG. 5A is a perspective view showing a primary coil of a transformer for an OBC of an electric vehicle according to a second embodiment of the present disclosure;

FIG. 5B is a sectional view showing the primary coil of FIG. 5A;

FIG. 6A is a perspective view showing a primary coil of a transformer for an OBC of an electric vehicle according to a third embodiment of the present disclosure;

FIG. 6B is a concept view showing winding of the primary coil of FIG. 6A;

FIG. 7 is a perspective view showing a primary coil of a transformer for an OBC of an electric vehicle according to a fourth embodiment of the present disclosure;

FIG. 8 is a separate perspective view showing upper and lower copper sheet coils located on upper and lower secondary coil elements of the transformer for the OBC according to the present disclosure;

FIG. 9 is a sectional view showing an adhesion type covered conductive wire for forming the primary coil of the transformer for the OBC according to the present disclosure;

FIG. 10A is a concept view showing a schematic outer shape of a thin copper wire of the adhesion type covered conductive wire for forming the primary coil of the transformer for the OBC according to the fourth embodiment of the present disclosure; and

FIG. 10B is a sectional view showing the adhesion type covered conductive wire for forming the primary coil of the transformer for the OBC according to the fourth embodiment of the present disclosure; and

FIG. 10C is a concept view showing the outer shape of the adhesion type covered conductive wire in the transformer for the OBC according to the fourth embodiment of the present disclosure, in which multiple thin copper wires are exposed to the outside.

### DETAILED DESCRIPTION OF THE EMBODIMENTS

Hereinafter, an explanation of a transformer for an OBC of an electric vehicle according to embodiments of the present disclosure will be given in detail with reference to the attached drawings.

According to embodiments of the present disclosure, there is provided a transformer A for an OBC of an electric vehicle, the OBC of the electric vehicle being adapted to charge a high-voltage battery of the electric vehicle with commercial AC power (200V AC) supplied from an electric vehicle charger, the transformer A including: a flat primary coil 110, 120, 130, or 140 for receiving current from the electric vehicle charger; a lower secondary coil element 210 located under the primary coil 110, 120, 130, or 140 in such a way as to come into close contact with an underside of the primary coil 110, 120, 130, or 140 and generate induced current by means of magnetic induction of the current flowing to the primary coil 110, 120, 130, or 140 to supply the generated induced current to the high-voltage battery; and an upper secondary coil element 220 located above the primary coil 110, 120, 130, or 140 in such a way as to come into close contact with a top of the primary coil 110, 120, 130, or 140 and generate induced current by means of magnetic induction of the current flowing to the primary coil 110, 120, 130, or 140 to supply the generated induced current to the high-voltage battery.

Further, the primary coil 110, 120, 130, or 140 is formed of an adhesion type covered conductive wire 110′, 120′, 130′, or 140′ made by covering an insulating tape 110-2, 120-2, 130-2, or 140-2 on a conductive wire 110-1, 120-1, 130-1, or 140-1 and applying (coating) an adhesive onto the outer peripheral surface of the insulating tape 110-2, 120-2, 130-2, or 140-2 to form a bonding layer 110-3, 120-3, 130-3, or 140-3.

Further, the primary coil 110, 120, 130, or 140 is provided to the form of a hard coil by winding the adhesion type covered conductive wire 110′, 120′, 130′, or 140′ in such a way as to have multiple turns by means of a winding member (not shown), while forming a first central hole C1, C2, C3, or C4 on a center thereof, fusing and curing the applied bonding layer 110-3, 120-3, 130-3, or 140-3 with a solvent (e.g., alcohol) or heat (hot air), and joining and aligning (without any irregular outer peripheral surfaces) the close contact portions of the adhesion type covered conductive wire 110′, 120′, 130′, or 140′ by means of the fusing.

Accordingly, no insulation breakdown occurs even at a high voltage in the range of several to tens of kV, while an efficiency between the primary coil and the secondary coil elements is being kept.

The winding member is a winding jig or winder.

The adhesive is an adhesive paint.

The insulating tape 110-2, 120-2, 130-2, or 140-2 is a Kapton tape.

In this case, the conductive wire 110-1, 120-1, 130-1, or 140-1 is located inside the insulating tape 110-2, 120-2, 130-2, or 140-2 serving as an outer covering, and therefore, the conductive wire 110-1, 120-1, 130-1, or 140-1 is called ‘inner conductive core’.

Further, as mentioned above, the transformer A for the OBC of the electric vehicle according to the embodiments of the present disclosure serves to convert the high-frequency alternating current voltage outputted from a second converter of the OBC into a high voltage and to physically insulate the 220 V AC and the high-voltage battery from each other.

The primary coil 110, 120, 130, or 140 includes an input wire portion 111, 121, 131, or 141 connected to the electric vehicle charger (especially to the second converter of the OBC) and formed of the adhesion type covered conductive wire 110′, 120′, 130′, or 140′ of a linear type, a primary coil wound portion 112, 122, 132, or 142 extending from the input wire portion 111, 121, 131, or 141 and formed by winding the adhesion type covered conductive wire 110′, 120′, 130′, or 140′ in such a way as to have multiple turns to the form of a flat plate, while forming the first central hole C1, C2, C3, or C4 on the center thereof, and an output wire portion 113, 123, 133, or 143 formed of the adhesion type covered conductive wire 110′, 120′, 130′, or 140′ of a linear type in such a way as to be connected from the end of the primary coil wound portion 112, 122, 132, or 142 to the electric vehicle charger, and the primary coil wound portion 112, 122, 132, or 142 is formed in a hard state by automatically winding the adhesion type covered conductive wire 110′, 120′, 130′, or 140′ to the form of the flat plate by means of the winding member so that the wound portions of the adhesion type covered conductive wire 110′, 120′, 130′, or 140′ are brought into close contact with one another and simultaneously aligned in a horizontal direction and/or in a vertical direction (that is, in both horizontal and vertical directions or in either horizontal or vertical direction), fusing and curing the coated bonding layer 110-3, 120-3, 130-3, or 140-3 with a solvent (e.g., alcohol) or heat (hot air), and joining and aligning (without any irregular outer peripheral surfaces) the close contact portions of the adhesion type covered conductive wire 110′, 120′, 130′, or 140′ by means of the fusing.

Accordingly, no insulation breakdown occurs even at a high voltage in the range of several to tens of kV, and a distance between the primary coil and the adjacent secondary coil element decreases, while a degree of contact therebetween is increasing, so that a loss therebetween is reduced to improve an efficiency therebetween.

Furthermore, well-known conductive wires may be used freely as the conductive wires 110-1, 120-1, 130-1, and 140-1 covered with the insulating tapes 110-2, 120-2, 130-2, and 140-2.

Next, an explanation of the configurations of the primary coils 110, 120, 130, and 140 of the transformer A for the OBC of the electric vehicle according to the embodiments of the present disclosure will be given in detail.

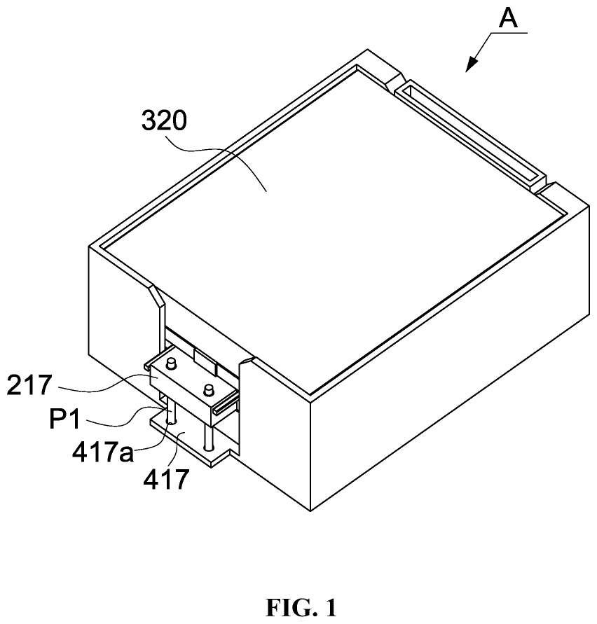

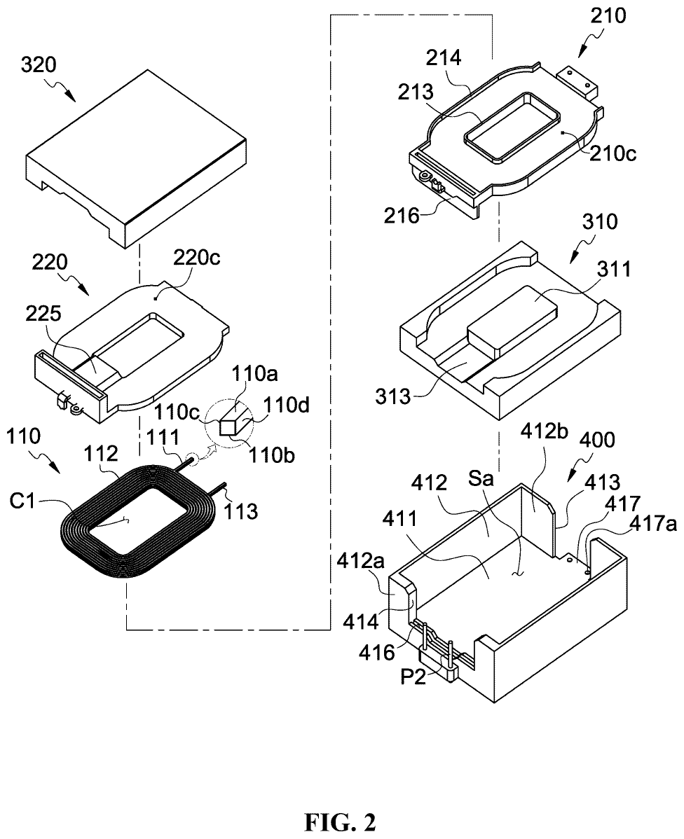

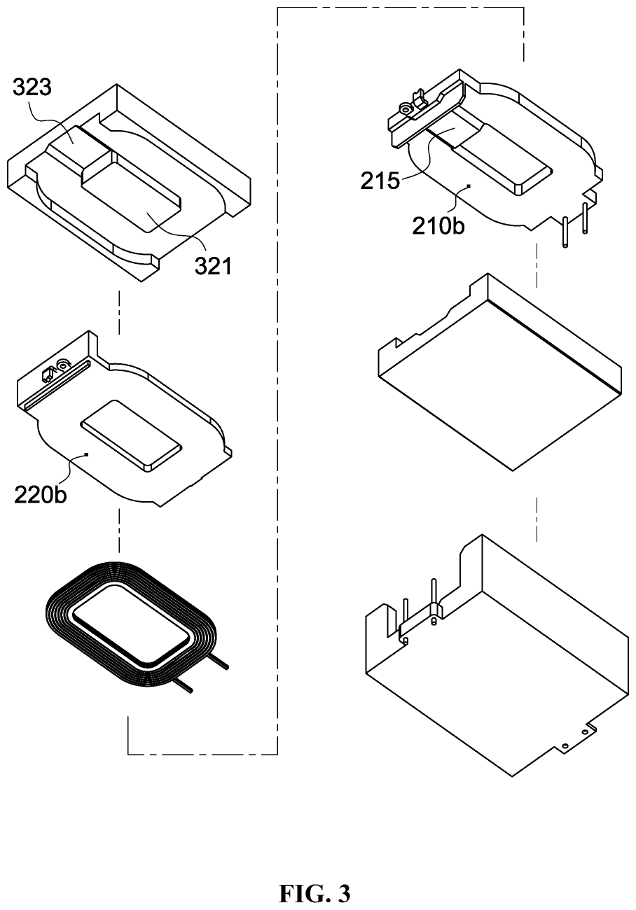

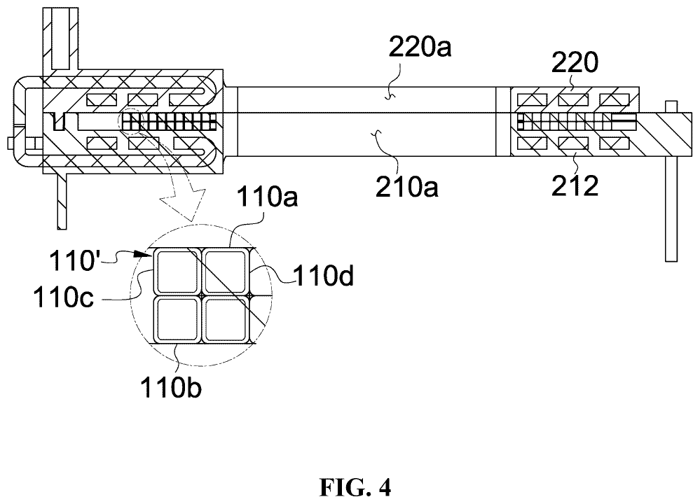

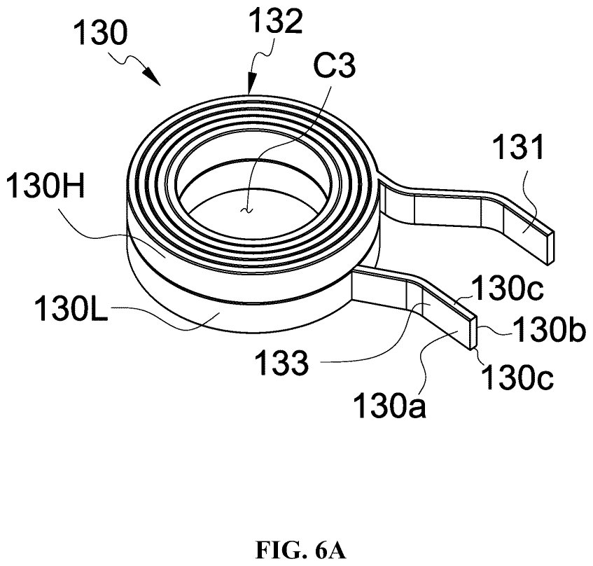

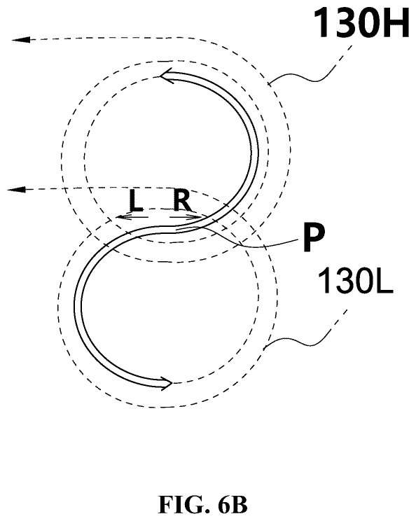

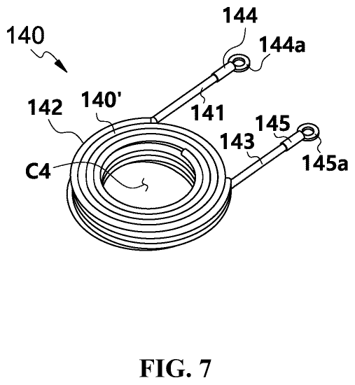

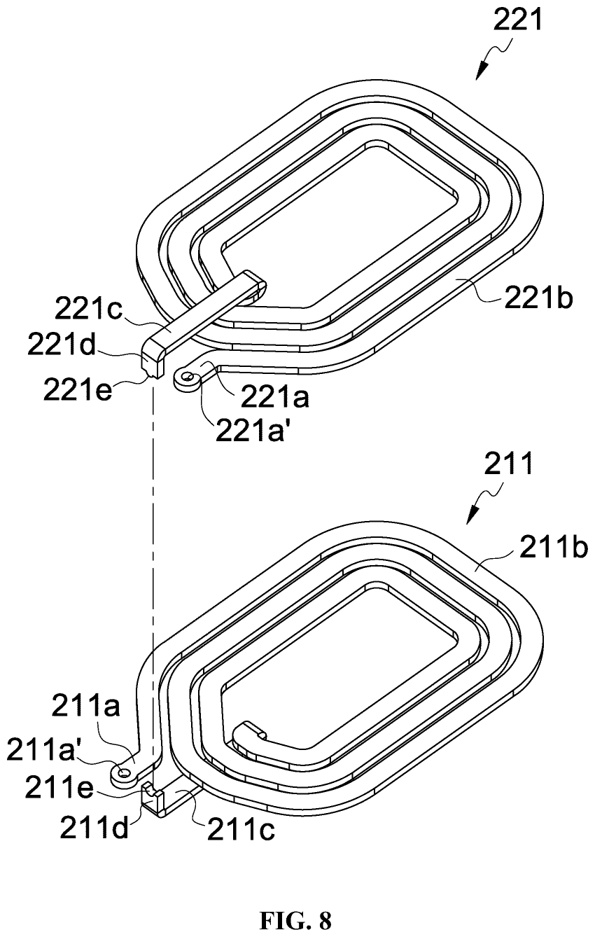

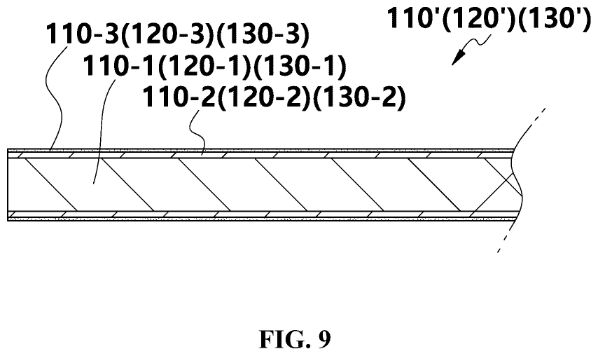

The primary coil 110, 120, 130, or 140 has the shape of a rectangle or circle according to the embodiments of the present disclosure. For example, as shown in FIGS. 1 to 5B, the primary coils 110 and 120 have the shapes of the rectangles with the rectangular first central holes C1 and C2, and as shown in FIGS. 6A and 7, the primary coils 130 and 140 have the shapes of the circles with the circular first central holes C3 and C4. In any case, such primary coils may be within the technical scope of the present disclosure.

The conductive wires 110-1, 120-1, and 130-1 of the primary coils 110, 120, and 130 are formed of flat copper wires (flat thin copper wires) having a flat top, a flat underside, and flat sides between the flat top and the flat underside in a longitudinal direction thereof.

In this case, if the insulating tapes 110-2, 120-2, and 130-2 are covered on the conductive wires 110-1, 120-1, and 130-1 composed of the flat top, the flat underside, and the sides and the bonding layers 110-3, 120-3, or 130-3 are applied onto the outer peripheral surfaces of the insulating tapes 110-2, 120-2, and 130-2, the flat adhesion type covered conductive wires 110′, 120′, or 130′, which have flat tops 110a, 120a, and 130a and flat undersides 110b, 120b, and 130b formed on tops and undersides thereof in longitudinal directions, are formed, and accordingly, the flat adhesion type covered conductive wires 110′, 120′, and 130′ are wound to have multiple turns, while forming the first central holes C1, C2, and C3 on the centers thereof, and thus provided as the flat primary coils 110, 120, and 130.

As shown in FIGS. 1 to 4, the adhesion type covered conductive wire 110′ of the primary coil 110 has a flat left side 110c and a flat right side 110d as the sides thereof, and the primary coil 110 is formed of the adhesion type covered conductive wire 110′ wound spirally in a horizontal direction, while allowing the flat left side 110c to face the flat right side 110d.

That is, the primary coil 110 is formed of the adhesion type covered conductive wire 110′ wound spirally in the horizontal direction in such a way as to allow the flat left side 110c as one surface of the flat sides to face the flat right side 110d as the flat side adjacent thereto.

In this case, as shown in FIGS. 1 to 4, the primary coil 110, which is formed of the flat adhesion type covered conductive wire 110′ wound to extend in a horizontal direction, is called the horizontally extending flat primary coil 110.

The primary coil 110 is formed of the adhesion type covered conductive wire 110′ wound spirally in the horizontal direction in such a way as to allow the flat left side 110c and the flat right side 110d to have a face-to-face contact with each other.

Next, the primary coil 120 according to the second embodiment of the present disclosure will be described.

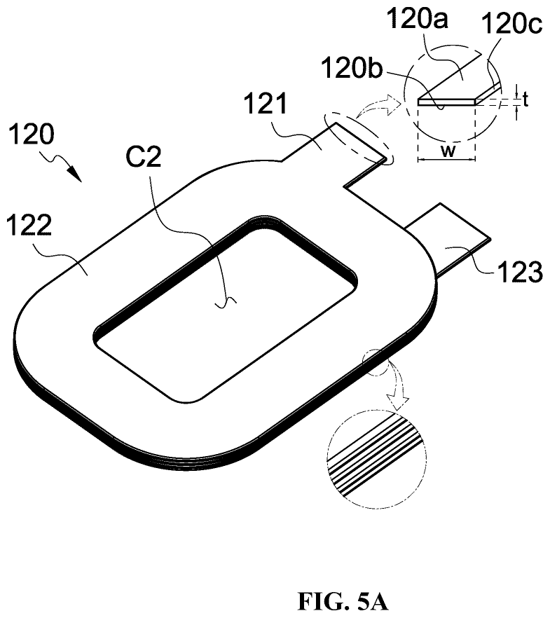

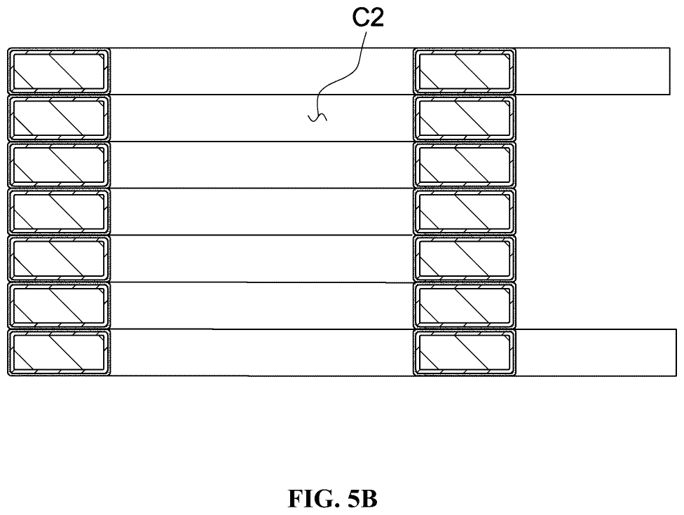

Referring first to FIGS. 5A and 5B, the second embodiment in which the primary coil 120 is provided to be stacked in upward and downward directions will be explained.

As shown in FIGS. 5A and 5B, a width w of the flat adhesion type covered conductive wire 120′ constituting the primary coil 120 is greater than a thickness t thereof, and the primary coil 120 is formed of the flat adhesion type covered conductive wire 120′ wound spirally in such a way as to be stacked vertically, while allowing the flat top 120a to face the flat underside 120b.

That is, the primary coil 120 is formed of the flat adhesion type covered conductive wire 120′ wound spirally in such a way as to be stacked vertically, while allowing the flat underside 120b to be located just on top of the flat top 120b and allowing the flat underside 120b to be located on the flat top 120a located just on top of the corresponding flat underside 120b, sequentially.

In this case, as shown in FIGS. 5A and 5B, the primary coil 120, which is formed of the flat adhesion type covered conductive wire 120′ wound spirally to extend in the vertical direction, is called the vertically extending flat primary coil 120.

The primary coil 120 is formed of the adhesion type covered conductive wire 120′ wound spirally in the vertical direction in such a way as to allow the flat top 120a and the flat underside 120b to have a face-to-face contact with each other.

According to another embodiment of the present disclosure, the primary coil 120 may be formed of the adhesion type covered conductive wire 110′ wound spirally in the vertical direction in such a way as to form a gap between the flat top 120a and the flat underside 120b.

Next, the third embodiment of the present disclosure wherein the primary coil 130 extends vertically and horizontally will be described.

As shown in FIGS. 6A and 6B, a width w of the flat adhesion type covered conductive wire 130′ constituting the primary coil 130 is greater than a thickness t thereof, and the primary coil 130 is formed of the flat adhesion type covered conductive wire 130′ standing in such a way as to allow the flat top 130a and the flat underside 130b to be vertical with respect to the lower secondary coil element 210, especially a lower insulator 212 and then wound spirally in a horizontal (left and right) direction in such a way as to allow the flat top 130a to face the flat underside 130b.

The primary coil 130 consists of a lower layer primary coil 130L that is formed of the flat adhesion type covered conductive wire 130′ standing in such a way as to allow the flat top 130a and the flat underside 130b to be vertical with respect to the lower secondary coil element 210, especially the lower insulator 212 and then wound spirally in a horizontal (left and right) direction in such a way as to allow the flat top 130a to face the flat underside 130b and an upper layer primary coil 130H extending upward from the lower layer primary coil 130L and formed of the flat adhesion type covered conductive wire 130′ standing in such a way as to allow the flat top 130a and the flat underside 130b to be vertical with respect to the lower secondary coil element 210, while coming into close contact with the sides of the lower layer primary coil 130L, and then wound spirally in a horizontal direction in such a way as to allow the flat top 130a to face the flat underside 130b.

In this case, the primary coil 130 is formed of the adhesion type covered conductive wire 130′ wound spirally to extend in the horizontal direction in such a way as to allow the flat top 130a and the flat underside 130b to have a face-to-face contact with each other.

In detail, the lower layer primary coil 130L is wound spirally to extend in the horizontal direction in such a way as to allow the flat top 130a and the flat underside 130b to have a face-to-face contact with each other, and the upper layer primary coil 130H is wound spirally to extend in the horizontal direction in such a way as to allow the flat top 130a and the flat underside 130b to have a face-to-face contact with each other.

In this case, as shown in FIG. 6A, the primary coil 130, which is formed of the flat adhesion type covered conductive wire 130′ wound spirally to extend in the horizontal direction, is called the horizontally extending flat primary coil 130.

According to another embodiment of the present disclosure, each of the upper layer primary coil 130H and the lower layer primary coil 130L may be formed of the adhesion type covered conductive wire 130′ wound spirally to extend in the horizontal direction in such a way as to form a gap between the flat top 130a and the flat underside 130b.

Now, an explanation of a method for winding the horizontally extending flat primary coil 130 will be given briefly.

As shown in FIG. 6B, the upper layer primary coil 130H is formed by counterclockwisely winding the flat adhesion type covered conductive wire 130′ in one direction R around a center P of the flat adhesion type covered conductive wire 130′, and next, the lower layer primary coil 130L is formed by counterclockwisely winding the flat adhesion type covered conductive wire 130′ in the other direction L as the opposite direction to one direction R around the center P.

As mentioned above, the primary coils 110, 120, and 130 themselves of the transformers for the OBC according to the embodiments of the present disclosure are formed of the flat adhesion type covered conductive wires 110′, 120′, and 130′ wound to have face-to-face contacts, thereby achieving high degrees of contact, and further, degrees of contact between the primary coils 110, 120, and 130 and the corresponding secondary coils are improved, so that a loss between them is reduced to provide a high efficiency and a height of a transformer product is lowered to allow the product to be small in size.

As a result, the height and size of the transformer for the OBC are decreased, which enables the OBC itself to be reduced in size, so that the space occupied by the OBC in the electric vehicle is small and the OBC is lightweight, thereby improving product competitiveness of the OBC of the electric vehicle.

The thicknesses t of the primary coils 120 and 130 are in the range of 0.1 to 1.0 mm and the widths w thereof are in the range of 2.0 to 10.0 mm.

Desirably, the thicknesses t of the primary coils 120 and 130 are in the range of 0.3 to 0.8 mm and the widths w thereof are in the range of 3.0 to 8.0 mm.

More desirably, the thicknesses t of the primary coils 120 and 130 are in the range of 0.4 to 0.7 mm and the widths w thereof are in the range of 4.0 to 7.0 mm.

The primary coil 130 as shown in FIGS. 6A and 6B and the primary coil 140 as shown in FIG. 7 have the shapes of the circles with the first central holes C3 and C4 shaped as circles, but they are just exemplary for the conveniences of the description.

Like the primary coil 110 as shown in FIGS. 1 to 5B, the primary coil 130 as shown in FIGS. 6A and 6B and the primary coil 140 as shown in FIG. 7 may have the shapes of the rectangles with the first central holes C3 and C4 shaped as rectangles. In any case, such primary coils may be within the technical scope of the present disclosure.

Next, the primary coil 140 according to the fourth embodiment of the present disclosure will be described with respect to FIG. 7.

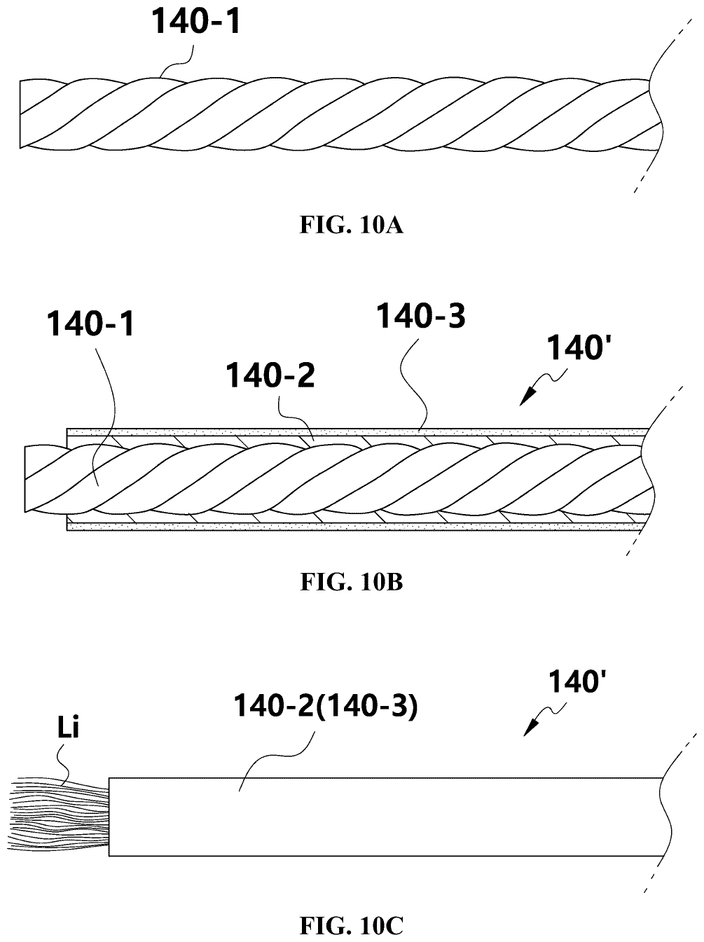

Referring first to FIGS. 10A to 10C, the conductive wire 140-1 of the adhesion type covered conductive wire 140′ of the primary coil 140 is formed of a thin copper wire 140-1 made by twisting multi-stranded thin copper wires Li.

The primary coil 140 includes a first input terminal 144 connected conductively to the end of the input wire portion 141 and having a first input terminal fixing hole 144a formed thereon and a first output terminal 145 connected conductively to the end of the output wire portion 143 and having a first output terminal fixing hole 145a formed thereon.

Under the above configuration, the wiring work for the transformer A for the OBC can be performed more easily and conveniently.

The primary coil 140 is wound to allow the input wire portion 141 and the output wire portion 143 to be arranged toward the electric vehicle charger in the same direction as each other.

Next, an explanation of configurations of the secondary coil elements will be given.

The lower secondary coil element 210 includes a plate-shaped lower copper sheet coil 211 formed by spirally winding a thin copper sheet and the lower insulator 212 made of a synthetic resin, having a lower central hole 210a, and building the lower copper sheet coil 211 except lower terminals 211a and 211c therein, and the upper secondary coil element 220 includes a plate-shaped upper copper sheet coil 221 formed by spirally winding a thin copper sheet and an upper insulator 222 made of a synthetic resin, having an upper central hole 220a, and building the upper copper sheet coil 221 except upper terminals 221a and 221c therein. In this case, the underside of the primary coil 110, 120, 130, or 140 comes into close contact with a top 210b of the lower secondary coil element 210 (that is, a top of the lower insulator 212), and the top of the primary coil 110, 120, 130, or 140 comes into close contact with an underside 220b of the upper secondary coil element 220 (that is, an underside of the upper insulator 212), so that the primary coil 110, 120, 130, or 140 is brought into close contact between the lower secondary coil element 210 and the upper secondary coil element 220.

As the primary coil 110, 120, 130, or 140 of the transformer A for the OBC is provided to the form of the flat coil, a height of the transformer A is reduced to a height of 60% of the conventional transformer for the OBC, and further, a size of the transformer A is reduced (to a size of 55% of the conventional transformer for the OBC).

As the height and size of the transformer A for the OBC are reduced, the OBC itself is decreased in size, so that the space occupied by the OBC in the electric vehicle becomes small and the OBC itself is lightweight, thereby improving the product competitiveness of the OBC of the electric vehicle.

As the coil is formed of the flat copper wire having the flat top and underside, further, the transformer A for the OBC is advantageous in converting large current, lowers an electrical loss, and decreases generation of heat.

Furthermore, a loss between the primary coil and the secondary coils of the transformer A for the OBC of the electric vehicle is decreased, thereby enhancing an efficiency therebetween.

According to the above-mentioned configurations of the primary coils 110, 120, 130, and 140 and the secondary coil elements 210 and 220, the primary coils 110, 120, 130, and 140 and the secondary coil elements 210 and 220 can supply large current and high voltage even if they are small in size.

As there is no need to doubly adopt a bobbin and a casing for holding the primary coil, the transformer A has excellent heating characteristics and high electromagnetic interference (EMI) shielding performance.

Now, the configurations of the upper and lower secondary coil elements 220 and 210 will be explained in detail.

The lower secondary coil element 210 is formed of the copper sheet having thickness and sectional area greater than non-flexible reference thickness and sectional area, and the upper secondary coil element 220 is formed of the copper sheet having thickness and sectional area greater than non-flexible reference thickness and sectional area.

Like this, the secondary coil elements are formed of such non-flexible thick copper sheets, thereby being advantageous in the conversion of large current and high voltage.

The lower copper sheet coil 211 includes the lower first terminal 211a having a terminal hole 211a′ formed thereon, a lower spiral portion 211b formed by spirally winding the copper sheet extending from the lower first terminal 211a in such a way as to have multiple turns, while having gaps through which the wound portions of the copper sheet do not come into contact with each other, and the lower second terminal 211c bent downward from the lower spiral portion 211b and transversing the lower spiral portion 211b toward the lower first terminal 211a, and the upper copper sheet coil 221 includes the upper first terminal 221a having a terminal hole 221a′ formed thereon, an upper spiral portion 221b formed by spirally winding the copper sheet extending from the upper first terminal 221a in such a way as to have multiple turns, while having gaps through which the wound portions of the copper sheet do not come into contact with each other, and the upper second terminal 221c bent downward from the upper spiral portion 221b and transversing the upper spiral portion 221b toward the upper first terminal 221a.

In the transformer A for the OBC of the electric vehicle according to the embodiment of the present disclosure, the lower copper sheet coil 211 further includes a lower bridge 211d bent vertically upwardly from the end of the lower second terminal 211c, and the upper copper sheet coil 221 further includes an upper bridge 221d bent vertically downwardly from the end of the upper second terminal 221c in such a way as to come into contact with the lower bridge 211d and be electrically connected to the lower bridge 211d. As the lower bridge 211d is connected to the upper bridge 221d, the lower secondary coil element 210 is connected in series with the upper secondary coil element 220.

In the transformer A for the OBC of the electric vehicle according to the embodiment of the present disclosure, the lower copper sheet coil 211 further includes a bridge groove 211e concave downward from the end of the lower bridge 211d and the upper copper sheet coil 221 further includes a bridge protrusion 221e protruding downward from the end of the upper bridge 221d, so that the bridge protrusion 221e is fitted to the bridge groove 211e to allow the lower bridge 211d and the upper bridge 221d to be brought into close contact with each other and electrically connected to each other.

The transformer A for the OBC of the electric vehicle according to the embodiment of the present disclosure further includes an upper magnetic core 320 located on top of the upper secondary coil element 220 in such a way as to cover the outer surfaces of the upper secondary coil element 220 and a lower magnetic core 310 located on the underside of the lower secondary coil element 210 in such a way as to cover the outer surfaces of the lower secondary coil element 210. Further, the lower secondary coil element 210 has a lower alignment protrusion 215 protruding downward from one side of the underside 210b thereof (from the left side where the terminals are present), and the upper secondary coil element 220 has an upper alignment protrusion 225 protruding downward from one side of the top 220c thereof (from the left side where the terminals are present). Furthermore, the lower magnetic core 310 has a lower seating groove 313 concave downward outward from one side of a middle leg 311 thereof in such a way as to fit the lower alignment protrusion 215 thereto, and the upper magnetic core 320 has an upper seating groove 323 concave upward outward from one side of a middle leg 321 thereof in such a way as to fit the upper alignment protrusion 225 thereto.

As a result, the seating grooves 313 and 323 for fitting the alignment protrusions 215 and 225 are formed outward from one side of the middle legs 311 and 321, so that the upper and lower magnetic cores 320 and 310 are aligned with the assembly of the primary coil 110, 120, 130, or 140 and the upper and lower secondary coil elements 210 and 220 easily, accurately, and quickly.

In the transformer A for the OBC of the electric vehicle according to the embodiment of the present disclosure, as the top 210c of the lower secondary coil element 210 and the underside 220b of the upper secondary coil element 220 are flat surfaces, the lower secondary coil element 210 has outer protrusion edges 214 protruding upward from the lower insulator 210 along the outer edges of the top 210c in such a way as to hold the outer edges of the primary coil 110, 120, 130, or 140 brought into close contact between the top 210c of the lower secondary coil element 210 and the underside 220b of the upper secondary coil element 220 and inner protrusion edges 213 brought into close contact with the first central hole C1, C2, C3, or C4 of the primary coil 110, 120, 130, or 140 in such a way as to hold the inner edges of the first central hole C1, C2, C3, or C4 of the primary coil 110, 120, 130, or 140.

Desirably, as shown, the inner protrusion edges protrude from the inner edges of the first central hole C1, C2, C3, or C4.

Further, the outer protrusion edges 214 and the inner protrusion edges 213 serve to hold the primary coil 110, 120, 130, or 140 to allow the corresponding primary coil to be located on the same position as the upper and lower copper sheet coils 221 and 211 (that is, on the position where the centers are aligned in upward and downward directions), so that the center of the primary coil is aligned with the centers of the upper and lower copper sheet coils 221 and 211, without being eccentric with respect to them.

Desirably, the upper secondary coil element 220 serves to push the primary coil 110, 120, 130, or 140 thereagainst, thereby preventing the corresponding primary coil from having a gap or movement.

The lower insulator 212 is made by inserting the lower copper sheet coil 211 into an injection mold and performing insert molding for the lower copper sheet coil 211 by means of resin injection, and the upper insulator 222 is made by inserting the upper copper sheet coil 221 into an injection mold and performing insert molding for the upper copper sheet coil 221 by means of resin injection.

That is, the lower insulator 212 and the upper insulator 222 are made by inserting the lower copper sheet coil 211 and the upper copper sheet coil 221 into injection molds and performing insert molding for the lower copper sheet coil 211 and the upper copper sheet coil 221 by means of resin injection.

Desirably, the inner protrusion edges 213 and the outer protrusion edges 214 are formed unitarily with the lower insulator 212 by means of the insert molding.

As a result, the inner protrusion edges 213, the outer protrusion edges 214, and the lower insulator 212 are simultaneously made by means of one-time injection.

Desirably, the lower copper sheet coil 211 and the upper copper sheet coil 221 have a thickness in the range of 1.8 to 2.2 mm.

More desirably, the lower copper sheet coil 211 and the upper copper sheet coil 221 have a thickness of 2.0 mm.

The transformer A for the OBC of the electric vehicle according to the embodiment of the present disclosure further includes a mounting member 400 having a flat plate-shaped base 411 and an edge portion 412 protruding upward from the edges of the base 411 to form a seating space portion Sa therein, so that the mounting member 400 serves to mount the assembly of the lower magnetic core 310, the lower secondary coil element 210, the primary coil 110, 120, 130, or 140, the upper secondary coil element 220, and the upper magnetic core 320 into the seating space portion Sa, without any movement or gap.

In the transformer A for the OBC of the electric vehicle according to the embodiment of the present disclosure, further, the edge portion 412 of the mounting member 400 is rectangular, and the mounting member 400 includes a second groove 414 formed on a left side surface 412a of the edge portion 412 where the terminals 211a and 221a of the secondary coil elements 210 and 220 are located in such a way as to pass the terminals 211a and 221a of the secondary coil elements 210 and 220 therethrough to allow the terminals 211a and 221a to be connected to secondary connection pins P2 and a first groove 413 formed on a right side surface 412b of the edge portion 412 where the terminals of the primary coil 110, 120, 130, or 140 are located in such a way as to pass a primary terminal stand 217 to which primary terminal pins P1 are fastened therethrough. Accordingly, the lower secondary coil element 210 further includes a fitting plate 216 protruding downward from the left side end of the underside 210b thereof, and the mounting member 400 further includes a fitting slit 416 concave downward from the left side surface 412a where the second groove 413 is formed in such a way as to fastenedly fit the fitting plate 216 thereto.

In the transformer A for the OBC of the electric vehicle according to the embodiment of the present disclosure, the lower secondary coil element 210 further includes the primary terminal stand 217 extending from the right side of the lower insulator 212 thereof in such a way as to be fastened to the primary terminal pins P1, and the mounting member 400 further includes a reinforcing plate 417 protruding from the edge of the base 411 where the first groove 413 is formed in such a way as to extend horizontally with respect to the base 411 just below the primary terminal stand 217 and a pair of primary terminal holes 417a formed on the reinforcing plate 417 in such a way as to hold the lower peripheries of the primary terminal pins P1 fastened to the primary terminal stand 217.

Under the above-mentioned simple configuration, tops and undersides of the primary terminal pins P1 are simultaneously held reliably by means of the primary terminal stand 217 and the reinforcing plate 417.

As described above, the transformer A for the OBC of the electric vehicle according to the embodiments of the present disclosure has the following advantages.

Firstly, the primary coil and the secondary coil elements can be kept insulated from one another even at a high voltage in the range of several to tens of kV.

Secondly, winding uniformization and alignment of the primary coil and the secondary coil elements can be ensured, thereby improving efficiencies and EMI shielding performance (greater by 3 to 4 dB than that in the conventional transformer for the OBC).

Thirdly, the primary coil and the secondary coil elements can be provided to the form of the flat coils to allow the sectional areas and the surface areas thereof to increase, thereby improving skin effect and reducing the generation of heat.

Fourthly, the number of processes can be decreased to achieve the reduction in the machining cost.

Fifthly, the height and volume (size) of the transformer for the OBC can be reduced, so that the space occupied by the OBC in the electric vehicle becomes small, thereby improving the product competitiveness of the OBC of the electric vehicle.

Sixthly, a loss between the primary coil and the secondary coil elements can be decreased, thereby enhancing efficiency therebetween.

Seventhly, even if the transformer is small in size, the transformer can supply large current and high voltage.

Eighthly, the degree of contact of the primary coil can be improved.

Ninthly, the number of assembling processes for the primary coil can be reduced (to 50% of the processes for the conventional transformer for the OBC), thereby improving product productivity and price competitiveness.

Tenthly, the wiring work of the primary coil to the secondary coil elements can be performed very easily, conveniently, and accurately, and further, no additional terminal arrangement (wiring) for the primary coil and the secondary coil elements can be needed.

Eleventhly, the wiring work of the transformer for the OBC with other parts can be performed easily and conveniently.

Twelfthly, the arrangements of the coils can be regular by using the flat copper wires, thereby achieving the uniformization in quality.

Lastly, the wiring work of the transformer for the OBC can be performed by even an unskilled worker quickly and accurately, without any erroneous wiring.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings.

It is therefore intended that the scope of the invention be limited not by this detailed description, but rather by the claims appended hereto.

What is claimed is:

1. A transformer for an on-board charger (OBC) of an electric vehicle, the OBC of the electric vehicle being adapted to charge a high-voltage battery of the electric vehicle with commercial AC power (200V AC) supplied from an electric vehicle charger, the transformer comprising:
a flat primary coil (110, 120, 130, or 140) for receiving current from the electric vehicle charger;
a lower secondary coil element (210) located under the primary coil (110, 120, 130, or 140) in such a way as to come into close contact with an underside of the primary coil (110, 120, 130, or 140) and generate induced current by means of magnetic induction of the current flowing to the primary coil (110, 120, 130, or 140) to supply the generated induced current to the high-voltage battery; and
an upper secondary coil element (220) located above the primary coil (110, 120, 130, or 140) in such a way as to come into close contact with a top of the primary coil (110, 120, 130, or 140) and generate induced current by means of magnetic induction of the current flowing to the primary coil (110, 120, 130, or 140) to supply the generated induced current to the high-voltage battery,
wherein the primary coil (110, 120, 130, or 140) is formed of an adhesion type covered conductive wire (110′, 120′, 130′, or 140′) made by covering an insulating tape (110-2, 120-2, 130-2, or 140-2) on a conductive wire (110-1, 120-1, 130-1, or 140-1) and applying an adhesive onto the outer peripheral surface of the insulating tape (110-2, 120-2, 130-2, or 140-2) to form a bonding layer (110-3, 120-3, 130-3, or 140-3), and the primary coil (110, 120, 130, or 140) is provided to the form of a hard coil by winding the adhesion type covered conductive wire (110′, 120′, 130′, or 140′) in such a way as to have multiple turns, while forming a first central hole (C1, C2, C3, or C4) on a center thereof, fusing and curing the applied bonding layer (110-3, 120-3, 130-3, or 140-3), and joining the close contact portions of the adhesion type covered conductive wire (110′, 120′, 130′, or 140′) by means of the fusing.

2. The transformer according to claim 1, wherein the primary coil (110, 120, 130, or 140) comprises:
an input wire portion (111, 121, 131, or 141) connected to the electric vehicle charger and formed of the adhesion type covered conductive wire (110′, 120′, 130′, or 140′) of a linear type;
a primary coil wound portion (112, 122, 132, or 142) extending from the input wire portion (111, 121, 131, or 141) and formed by winding the adhesion type covered conductive wire (110′, 120′, 130′, or 140′) in such a way as to have multiple turns to the form of a flat plate, while forming the first central hole (C1, C2, C3, or C4) on the center thereof; and
an output wire portion (113, 123, 133, or 143) formed of the adhesion type covered conductive wire (110′, 120′, 130′, or 140′) of a linear type in such a way as to be connected from the end of the primary coil wound portion (112, 122, 132, or 142) to the electric vehicle charger,
whereby the primary coil wound portion (112, 122, 132, or 142) is formed in a hard state by automatically winding the adhesion type covered conductive wire (110′, 120′, 130′, or 140′) to the form of the flat plate by means of the winding member so that the wound portions of the adhesion type covered conductive wire (110′, 120′, 130′, or 140′) are brought into close contact with one another and simultaneously aligned in a horizontal direction and/or in a vertical direction, fusing and curing the coated bonding layer (110-3, 120-3, 130-3, or 140-3), and joining and aligning the close contact portions of the adhesion type covered conductive wire (110′, 120′, 130′, or 140′) by means of the fusing.

3. The transformer according to claim 2, wherein the adhesion type covered conductive wire (110′) of the primary coil (110) has a flat left side (110c) and a flat right side (110d) as the sides thereof, and the primary coil (110) is formed of the adhesion type covered conductive wire (110′) wound spirally in a horizontal direction, while allowing the flat left side (110c) to have a face-to-face contact with the flat right side (110d).

4. The transformer according to claim 2, wherein the adhesion type covered conductive wire (120′) constituting the primary coil (120) has a width (w) greater than a thickness (t) thereof, and the primary coil (120) is formed of the adhesion type covered conductive wire (120′) wound spirally in such a way as to be stacked vertically, while allowing a flat top (120a) and a flat underside (120b) of the adhesion type covered conductive wire (120′) to face each other.

5. The transformer according to claim 2, wherein the adhesion type covered conductive wire (130′) constituting the primary coil (130) has a width (w) greater than a thickness (t) thereof, and the primary coil (130) is formed of the adhesion type covered conductive wire (130′) standing in such a way as to allow a flat top (130a) and a flat underside (130b) of the flat adhesion type covered conductive wire (130′) to be vertical with respect to the lower secondary coil element (210) and then wound spirally in a horizontal direction in such a way as to allow the flat top (130a) to face the flat underside (130b).

6. The transformer according to claim 5, wherein the primary coil (130) comprises:
a lower layer primary coil (130L) formed of the adhesion type covered conductive wire (130′) standing in such a way as to allow the flat top (130a) and the flat underside (130b) to be vertical with respect to the lower secondary coil element (210) and then wound spirally in the horizontal direction in such a way as to allow the flat top (130a) to face the flat underside (130b); and
an upper layer primary coil (130H) extending upward from the lower layer primary coil (130L) and formed of the adhesion type covered conductive wire (130′) standing in such a way as to allow the flat top (130a) and the flat underside (130b) to be vertical with respect to the lower secondary coil element (210), while coming into close contact with the sides of the lower layer primary coil (130L), and then wound spirally in a horizontal direction in such a way as to allow the flat top (130a) to face the flat underside (130b).

7. The transformer according to claim 2, wherein the conductive wire (140-1) of the adhesion type covered conductive wire (140′) of the primary coil (140) is formed of a thin copper wire (140-1) made by twisting multi-stranded thin copper wires (Li).

8. The transformer according to claim 2, wherein the primary coil (140) further comprises:
a first input terminal (144) connected conductively to the end of the input wire portion (141) and having a first input terminal fixing hole (144a) formed thereon; and
a first output terminal (145) connected conductively to the end of the output wire portion (143) and having a first output terminal fixing hole (145a) formed thereon,
whereby the primary coil (140) is wound to allow the input wire portion (141) and the output wire portion (143) to be arranged toward the electric vehicle charger in the same direction as each other.

9. The transformer according to claim 1, wherein the lower secondary coil element (210) comprises:
a plate-shaped lower copper sheet coil (211) formed by spirally winding a thin copper sheet; and
a lower insulator (212) made of a synthetic resin, having a lower central hole (210a), and building the lower copper sheet coil (211) except lower terminals (211a and 211c) therein, and
the upper secondary coil element (220) comprises:
a plate-shaped upper copper sheet coil (221) formed by spirally winding a thin copper sheet; and
an upper insulator (222) made of a synthetic resin, having an upper central hole (220a), and building the upper copper sheet coil (221) except upper terminals (221a and 221c) therein,
whereby the underside of the primary coil (110, 120, 130, or 140) comes into close contact with a top (210b) of the lower secondary coil element (210), and the top of the primary coil (110, 120, 130, or 140) comes into close contact with an underside (220b) of the upper secondary coil element (220), so that the primary coil (110, 120, 130, or 140) is brought into close contact between the lower secondary coil element (210) and the upper secondary coil element (220).

10. The transformer according to claim 9, wherein the lower secondary coil element (210) is formed of the copper sheet having thickness and sectional area greater than non-flexible reference thickness and sectional area, and the upper secondary coil element (220) is formed of the copper sheet having thickness and sectional area greater than non-flexible reference thickness and sectional area.
